(19) United States
(12) Patent Application Publication
(10) Pub. No.: US 2010/0252284 A1
(43) Pub. Date: Oct. 7, 2010

(54) Apparatus And Method For Combating Fires

(75) Inventor: Casey Johansen, Gilbert, AZ (US)

Correspondence Address: BRYAN CAVE LLP, TWO NORTH CENTRAL AVENUE, SUITE 2200, PHOENIX, AZ, 85004, US

(73) Assignee: Kodiac Investment, LLC, Gilbert, AZ (US)

(21) Appl. No.: 12/754,373

(22) Filed: Apr. 5, 2010

Related U.S. Application Data
(60) Provisional application No. 61/166,601, filed on Apr. 3, 2009.

(51) Int. Cl. A62C 2/00

(52) U.S. Cl. 169/46; 169/5

(57) ABSTRACT

In some embodiments, a fire fighting device can include: (a) a blower portion with an air input region and an air output region; (b) at least one container configured to hold a fire suppressing solution; (c) first piping; (d) a first pump mechanically coupled to the at least one container and configured to at least partially pump the fire suppressing solution from the at least one container into the first piping at a first pressure; (e) a second pump coupled to the first piping, the second pump is configured such that the second pump increases a pressure in at least a part of the first piping from the first pressure to a second pressure, the second pressure is greater than the first pressure; and (f) two or more nozzles located at the blower portion and mechanically coupled to the first piping such that the two or more nozzles are configured to emit the fire suppressing solution. Other embodiments are disclosed.

### CROSS-REFERENCE TO RELATED APPLICATIONS

This application claims the benefit of U.S. Provisional Application Ser. No. 61/166,601, filed Apr. 3, 2009. U.S. Provisional Application Ser. No. 61/166,601 is incorporated herein by reference.

### FIELD OF THE INVENTION

This invention relates generally to an apparatus and method for combating a fire, and relates more particularly to fire fighting apparatuses and methods used to fight forest and grassland fires.

### DESCRIPTION OF THE BACKGROUND

Forest and grass land fires in the western states are a constant concern because of the lack of moisture, the extremely short rainy season, regular high winds, and the generally long hot summers. Starting in the spring and continuing through the fall, the chance of serious fires is high because spring growth caused by winter rain and snow is dry and also because there is virtually no rain during the summer months. During the summer and fall, when a scrub brush or forest fire starts, it will generally spread rapidly and is extremely difficult to control. The result can be a loss of forest and buildings surrounding the area where the fire is burning.

Conventional methods for fighting fires under dry and windy conditions include the use of fire fighting vehicles for directing high pressure water or fire retardants at the fire. Fire fighters also use aircraft with water scoops to fight forest and brush fires.

However, fire fighters using these methods sometimes have only limited success in stopping the spread of the fire. For example, fire fighters can direct water at the fire from a nozzle, but this method results in the fire being controlled in only one extremely small area. Moreover, fire retardants are not safe to use in residential areas because they contain environmentally unsafe chemicals that are harmful to animals and humans. Use of aircraft with water scoops is very limited in that they cannot fly in high winds and that they take a significant amount of time to fill their scoops and return to the fire.

Accordingly, there is a need for an apparatus and method for combating forest and grass fires which is effective and efficient at fighting forest and brush fires.

### BRIEF DESCRIPTION OF THE DRAWINGS

To facilitate further description of the embodiments, the following drawings are provided in which:

FIG. 1 illustrates a front isometric view of a fire fighting apparatus, according to a first embodiment;

FIG. 2 illustrates a front view of a fan of the fire fighting apparatus of FIG. 1, according to the first embodiment;

FIG. 3 illustrates a front view of two or more nozzles of the fire fighting apparatus of FIG. 1, according to the first embodiment;

FIG. 4 illustrates a view of the nozzles of FIG. 3 and a portion of the fan of FIG. 2, according to the first embodiment;

FIG. 5 illustrates a view of a portion of the fire fighting apparatus of FIG. 1, according to the first embodiment;

FIG. 6 illustrates a view of another portion of the fire fighting apparatus of FIG. 1, according to the first embodiment;

FIG. 7 illustrates a view of a further portion of the fire fighting apparatus of FIG. 1, according to the first embodiment;

FIG. 8 illustrates a block diagram of a fire fighting device, according to a second embodiment;

FIG. 9 illustrates an isometric view of the fire fighting device of FIG. 8, according to the second embodiment;

FIG. 10 illustrates a back view of portions of a vehicle and a tank of the fire fighting device of FIG. 8, according to the second embodiment;

FIG. 11 illustrates an isometric side and front view of a blower portion, a holder portion, a blade, and a portion of an arm of the fire fighting device of FIG. 8, according to the second embodiment;

FIG. 12 illustrates a side diagram of the blower portion of the fire fighting device of FIG. 8, according to the second embodiment;

FIG. 13 illustrates an isometric front view of the blower portion and the holder portion of the fire fighting device of FIG. 8, according to the second embodiment;

FIG. 14 illustrates a side view of a screen and the piping of the fire fighting device of FIG. 8, according to the second embodiment; and

FIG. 15 illustrates a flow chart for an embodiment of a method of providing an apparatus for combating fires, according to an embodiment.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically and/or otherwise. Two or more electrical elements may be electrically coupled but not be mechanically or otherwise coupled; two or more mechanical elements may be mechanically coupled, but not be electrically or otherwise coupled; two or more electrical elements may be mechanically coupled, but not be electrically or otherwise coupled. Coupling may be for any length of time, e.g., permanent or semi permanent or only for an instant.

### DETAILED DESCRIPTION

In some embodiments, a fire fighting device can include: (a) a blower portion with an air input region and an air output region; (b) at least one container configured to hold a fire suppressing solution; (c) first piping; (d) a first pump mechanically coupled to the at least one container and configured to at least partially pump the fire suppressing solution from the at least one container into the first piping at a first pressure; (e) a second pump coupled to the first piping, the second pump is configured such that the second pump increases a pressure in at least a part of the first piping from the first pressure to a second pressure, the second pressure is greater than the first pressure; and (f) two or more nozzles located at the blower portion and mechanically coupled to the first piping such that the two or more nozzles are configured to emit the fire suppressing solution.

In other embodiments, an apparatus for combating fires can include: (a) a fan portion; (b) a vehicle portion; and (c) a tank portion. The fan portion can include: (a) a fan; (b) at least one first nozzle section coupled to an external diameter of an outlet of the fan; and (c) at least one second nozzle section coupled to the external diameter of the outlet of the fan and adjacent to the first nozzle section.

In yet further embodiments, a method of providing an apparatus for combating fires, can include: providing at least one fan; providing a vehicle; providing at least one tank; coupling the vehicle to the at least one fan and the at least one tank; providing two or more nozzles; coupling the two or more nozzle to an output of the at least one fan; and coupling the two or more nozzles to the at least one tank such that a fire suppressing solution can be pumped from the at least one tank to the two or more nozzles.

In one embodiment, an apparatus for combating fires, particularly large fires, such as, for example, forest fires, structure fires, brush fires, and tire fires, includes a fan that is coupled to two or more nozzles, a tank, at least one pump, and a vehicle. The apparatus can also be used to fight structure fires, tire fires, cardboard fires, pallet fires, etc. In some examples, it also can be used to knock smoke and dust out of the air. The apparatus can be used for multiple purposes when combating fires. For example, the apparatus can be used to prevent the spread of fires in addition to assisting to extinguish fires. That is, it is useful also to prevent the spread of fires, such as spraying down areas to keep the fire from spreading to that area (e.g., house/structure protection).

Not to be taken in a limiting sense, a simple example of an embodiment, a fire suppressing solution is pumped from the tank using the at least one pump to the two or more nozzles. The two or more nozzles are located at an output of a fan. A fine mist or stream of the fire suppressing solution can exit the two or more nozzles and be blown out of the apparatus and into the fire by the wind created by the fan. An operator of the vehicle can move the two or more nozzles and the fan to direct the stream of fire suppressing solution at particular areas of the fire. Embodiments of this apparatus allow a larger area of a fire to be sprayed with a fire suppressing solution in a shorter time compared with out terrestrial fire suppression delivery apparatuses and methods.

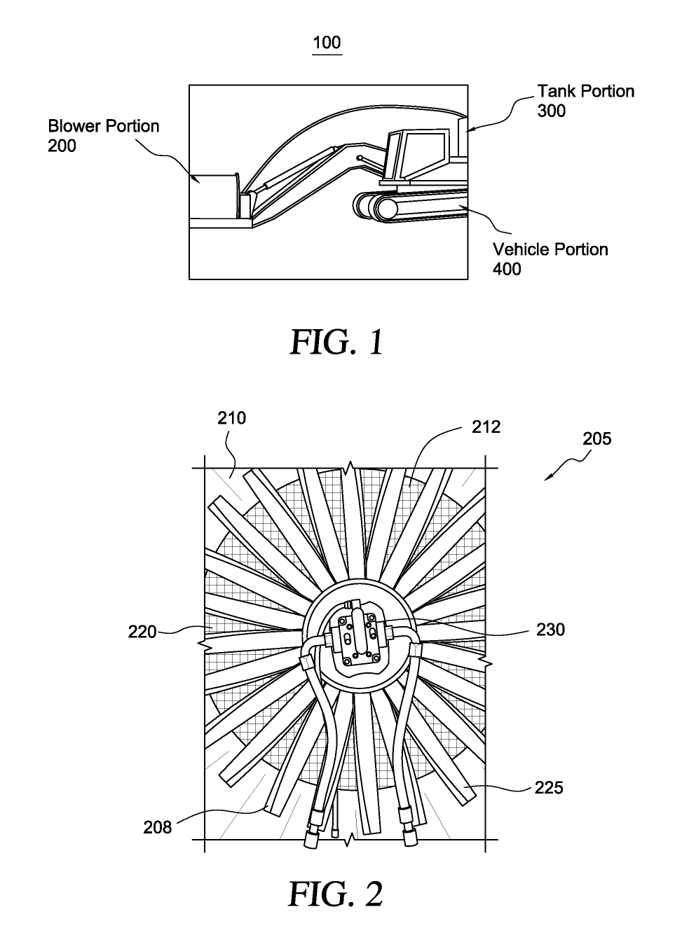

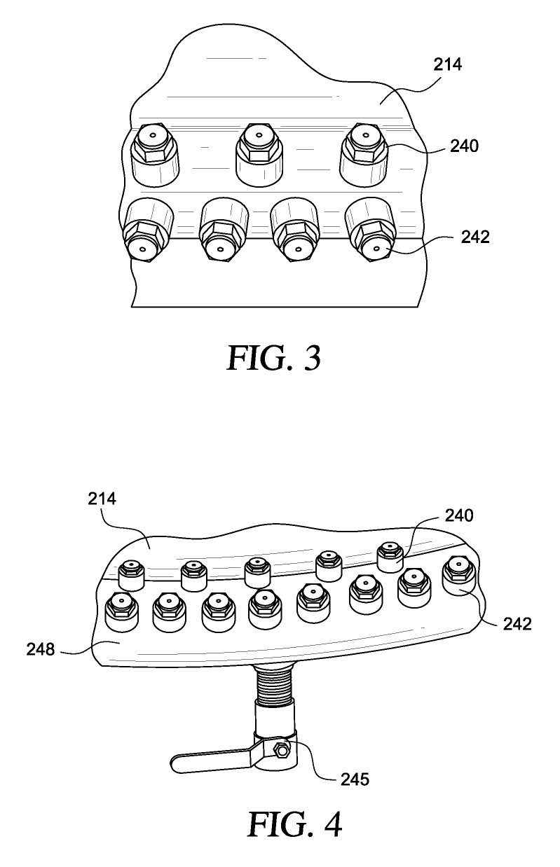

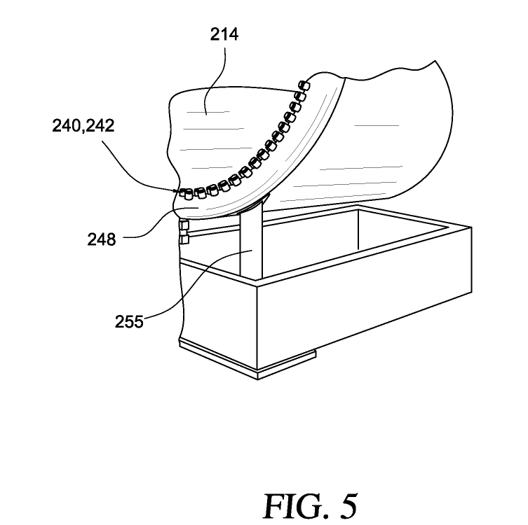

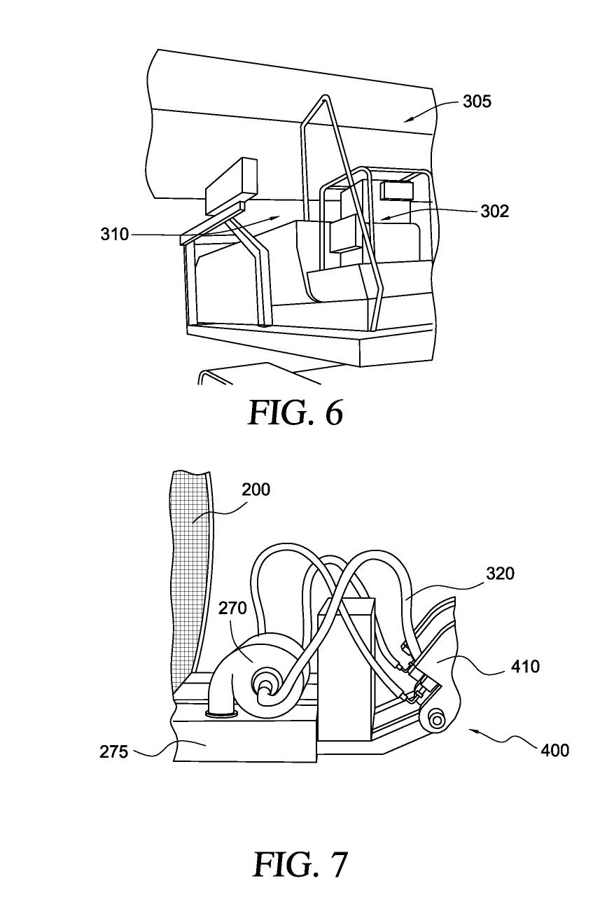

FIG. 1 illustrates a front isometric view of a fire fighting device or apparatus 100, according to a first embodiment. FIG. 2 illustrates a front view of a fan 205 of fire fighting apparatus 100, according to the first embodiment. FIG. 3 illustrates a front view of nozzles 240 and 242 of fire fighting apparatus 100, according to the first embodiment. FIG. 4 illustrates a view of a portion of nozzles 240 and 242 of fire fighting apparatus 100, according to the first embodiment. FIG. 5 illustrates a view of a portion of fire fighting apparatus 100, according to the first embodiment. FIG. 6 illustrates a view of another portion of fire fighting apparatus 100, according to the first embodiment. FIG. 7 illustrates a view of a further portion of fire fighting apparatus 100, according to the first embodiment. Fire fighting apparatus 100 is merely exemplary and is not limited to the embodiments presented herein. Fire fighting apparatus 100 can be employed in many different embodiments or examples not specifically depicted or described herein.

Referring to FIG. 1, fire fighting device or apparatus 100 can have blower portion 200, tank portion 300, and vehicle portion 400.

Blower portion 200 of fire fighting apparatus 100 can include a blowing device. Preferably, the blowing device is a fan, such as, for example fan 205 (FIG. 2). Other blowing devices can used, such as, for example, a jet engine.

With reference to FIG. 2, fan 205 has fan blades 208. Fan blades 208 can be pitched. Although fan blades 208 can be positioned at any location in fan housing 210, in one embodiment fan blades 208 are positioned closer to inlet 212 than to outlet 214 (FIG. 5). In addition, fan blades 208 can decrease in width as the blades run from the center of the fan to fan housing 210. For example, the widths of fan blades 208 closest to the center of fan 205 are greater than the widths of fan blades closest to fan housing 210. Fan 205 also can have protective screen 220 positioned over inlet 212. Protective screen 220 can be any type of device that prevents foreign objects from entering fan 205, while allowing air to pass through protective screen 220. Protective screen 220 must be strong enough to withstand the force applied to it from fan 205 when in operation.

Fan 205 can also comprise fan guide 225. Fan guide 225 is positioned between fan blades 208 and outlet 214 (FIG. 5). Fan guide 225 comprises a multitude of blade-like structures that extend from the center of fan 205 towards the internal diameter of fan housing 210. Fan guide 225 is stationary relative to the housing of fan housing 210 and is designed to help direct the wind produced from rotation of fan blades 208 when fan 205 is in operation. In some embodiments, fan guide 225 can be physically coupled to the internal diameter of fan housing 210.

Fan 205 also has fan motor 230. Fan motor 230 is coupled to fan blades 208. Fan motor causes fan blades 208 to rotate, thereby causing a wind velocity. Fan motor 230 can be any type of motor, including, for example, a hydraulic motor. Fan motor 230 can cause fan blades 208 to rotate at a variety of rotations per minute (RPMs). In one example, fan blades 208 rotate at approximately 1015 RPM. In general, fan blades 208 can be rotated at approximately 500-3000 RPM. In another example, fan blades rotate at approximately 750 RPM. Fan 205 can be operated according to the purpose of fire fighting apparatus 100. For example, if fire fighting apparatus 100 is being used to extinguish a fire, a lower wind velocity may be desired. If fire fighting apparatus 100 is being used to prevent the expansion of a fire, a higher wind velocity may be desired.

The internal diameter of fan housing 210 can change along the length of fan housing 210 from inlet 212 to outlet 214. For example, the internal diameter of fan housing 210 may decrease along the length of fan housing 210 from inlet 212 to outlet 214 to create an increase in wind velocity. In one embodiment, the internal diameter of fan housing 210 is approximately 84 inches at inlet 212 and is approximately 72 inches at outlet 214.

As seem in FIG. 3, fan 205 also has nozzles 242 positioned around the diameter of outlet 214 (FIG. 5) of fan housing 210. Nozzles 242 allow the fire suppressing solution being delivered to fan 205 to come out as a mist. Different nozzles can be used to create different sized fire suppressing solution droplets. For example, in one embodiment, #2 Whirljet nozzles from Spraying Systems Co. in Bellwood, Ill. are used. In some embodiments, fire suppressing solution droplets ranging anywhere from approximately 20 micrometers to approximately 400 micrometers can be created by nozzles 240 and/or 242.

Nozzles 242 are positioned such that the fire suppressing solution is emitted into the stream of air produced from the rotation of fan blades 208. Nozzles 242 can be positioned at any angle relative to the plane of the external diameter of fan housing 210 so that the fire suppressing solution is emitted anywhere from directly away from fan 205 (parallel with the plane of fan housing 210) to directly towards the center of outlet 214 (perpendicular to the plane of fan housing 210). In one embodiment, nozzles 242 are directed slightly towards the center of outlet 214 (i.e., more towards being parallel with the plane of fan housing 210 than towards being perpendicular to the plane of fan housing 210).

Fan 205 can also comprise a second ring of nozzles 240. Nozzles 240 are also positioned around the diameter of outlet 214. Nozzles 240 are positioned adjacent to nozzles 242 in a position that is closer to the inlet 212. Nozzles 240 can be positioned so that the fire suppressing solution is emitted anywhere from directly away from fan 205 to directly towards the center of fan blades 208. In one embodiment, nozzles 240 are directed so that the fire suppressing solution is emitted towards the center of outlet 214 (i.e., perpendicular to the plane of fan housing 210). In addition, nozzles 240 and 242 can have different angles of emission with respect to the plane of the exterior diameter of fan housing 210. For example, nozzles 240 can be directed closer toward the center of outlet 214 than nozzles 242. In many embodiments, nozzles 240 and 242 can be turned on and off together. In other embodiments, nozzles 240 and 242 can be turned on and off independently.

Fan 205 can have any number of nozzles 240 and 242. The number of nozzles 240 and 242 can be adjusted according to the amount of fire suppressing solution needed for delivery to fan 205. For example, in one embodiment, the fire suppressing solution is emitted out of nozzles 240 and 242 at a rate of 1.2 gallons/second. In another embodiment, the rate is approximately 0.5-3.0 gallons/second. In one embodiment, there are more external nozzles 242 than internal nozzles 240. For example, there are approximately twice as may nozzles 242 than nozzles 240. In one particular example, there are approximately 165 nozzles 242 and approximately 85 nozzles 240 along the 72 inch diameter of outlet 214. Fan 205 can also have more than 2 rings of nozzles.

Fan 205 can also have drain valve 245, as seen in FIG. 4. Drain valve 245 is used to drain fire suppressing solution that is in misting ring 248 circumscribing or otherwise located at outlet 214.

The fire suppressing solution emitted from nozzles 240 and 242 is stored in tank 305 (FIG. 6). Pump 302, as seen in FIG. 6, draws the fire suppressing solution out of tank 305 via piping 310. The fire suppressing solution can be any solution that helps put out fires, prevent fires, or retard fires. For example, the fire suppressing solution can comprise water, a chemical retardant, or a combination of the two. In addition, the fire suppressing solution can contain additives. As an example, the fire suppressing solution can comprise surfactants, such as those that help prevent the fire suppressing solution from evaporating at high temperatures. In one particular example, the fire suppressing solution comprises 99 parts water to one part surfactant by volume. For example, tank 305 can hold approximately 2000 gallons, with approximately 20 gallons of surfactant and approximately 1980 gallons of water.

Tank 305 can be coupled to vehicle portion 400 (FIG. 1) of fire fighting apparatus 100. Any method can be used to attach tank 305 to vehicle portion 400. In one embodiment, tank 305 is coupled to a support bracket. The support bracket is coupled to vehicle portion 400.

In addition, fire fighting apparatus 100 can comprise more than one tank. For example, there may be a tank for water and a separate tank for additives. Such additives can comprise, for example, surfactants and chemical flame retardants. The contents of the two tanks can be combined at any time, such as, for example, in piping 320 (FIG. 7) leading to fan 205 or in misting ring 248 (FIG. 4) of fan 205.

Pump 302 can be any type of pump including, for example, a gas pump or hydraulic pump. In one particular example, pump 302 is a 3-inch pump. Pump 302 pulls the fire suppressing solution out of tank 305 and pushes the fire suppressing solution towards blower portion 200 (FIG. 1) via piping 320.

With reference to FIG. 7, fire suppressing solution from piping 320 enters into pump 270. Pump 270 is used to increase the pressure of the fire suppressing solution as it passes into nozzles 240 and 242. Pump 270 can be any type of pump used to force fire suppressing solution along pipes. In one example, pump 270 can be a centrifugal water pump. In some embodiments, the pressure of the fire suppressing solution leaving pump 270 is from approximately 200 pounds per square inch (psi) to approximately 300 psi.

In other embodiments, pump 302 (FIG. 6) may be powerful enough so that there is no need for pump 270. Therefore, pump 302 would force fire suppressing solution out of tank 305 and into blower portion 200 (FIG. 1) with a pressure great enough that an additional pump is not necessary.

Upon leaving pump 270, the fire suppressing solution is forced into a pipe. The pipe can be contained within bottom bracket 275. Bottom bracket 275 is a portion of a base that supports fan 205 (FIG. 2). The base is coupled to fan 205 and also coupled to vehicle portion 400 (FIG. 1) of fire fighting apparatus 100. The pipe carrying the fire suppressing solution from pump 270 passes through bottom bracket 275 into portion 255 of the base, as can be seen in FIG. 5.

With continued reference to FIG. 5, the fire suppressing solution is transferred to nozzles 240 and 242 from the pipe in portion 255 via misting ring 248. Misting ring 248 is coupled to outlet 214. Misting ring 248 comprises a hollow space around the perimeter of outlet 214 in which the fire suppressing solution passes to reach nozzles 240 and 242. The fire suppressing solution passes from tank portion 300 (FIG. 1) of fire fighting apparatus 100 through vehicle portion 400 (FIG. 1) of fire fighting apparatus 100 via pipes until it arrives at blower portion 200.

As shown in FIG. 1, vehicle portion 400 of apparatus can be any vehicle that can support blower portion 200 and tank portion 300. An example of this type of vehicle includes heavy duty equipment, such as, for example, an excavator. One particular excavator that may be used is a 330BL Excavator from Caterpillar, Inc. in Peoria, Ill.

Returning to FIG. 7, the blower portion 200 is attached to vehicle portion 400 via the second member (e.g., an adjustable height portion) of the excavator at location 410. Therefore, the motion of blower portion 200 is controlled by the vehicle. For example, apparatus 100 can be arranged such that the boom controls the height of the blower portion 200. In addition, the stick cylinder of the excavator can control the tilt motion (i.e., the angle of the fan relative to the ground) of blower portion 200. Also, the swing of the excavator controls oscillation (i.e., side to side motion) of the blower portion 200. Furthermore, vehicle portion 400 is capable of moving tank portion 300 and blower portion 200 to various locations in which fire fighting apparatus 100 is needed.

Fire fighting apparatus 100 can be customized according to its specific purpose. For example, the wind velocity created by fan 205 can be adjusted. If fire fighting apparatus 100 is being used to extinguish a fire, a slower wind velocity may be desired to prevent a wind so strong that it would assist in spreading the fire. On the other hand, if fire fighting apparatus 100 is being used to prevent the spread of a fire, a higher wind velocity may be desired to spread the fire suppressing solution to a greater distance so a greater area is covered.

In addition, a variety of different fire suppressing solutions can be used. The fire suppressing solution can comprise 100% water, 100% of a chemical substance, or any combination of water and chemical substance. In addition, additives can be added to the fire suppressing solution. For example, a surfactant can be added to prevent the evaporation of the fire suppressing solution.

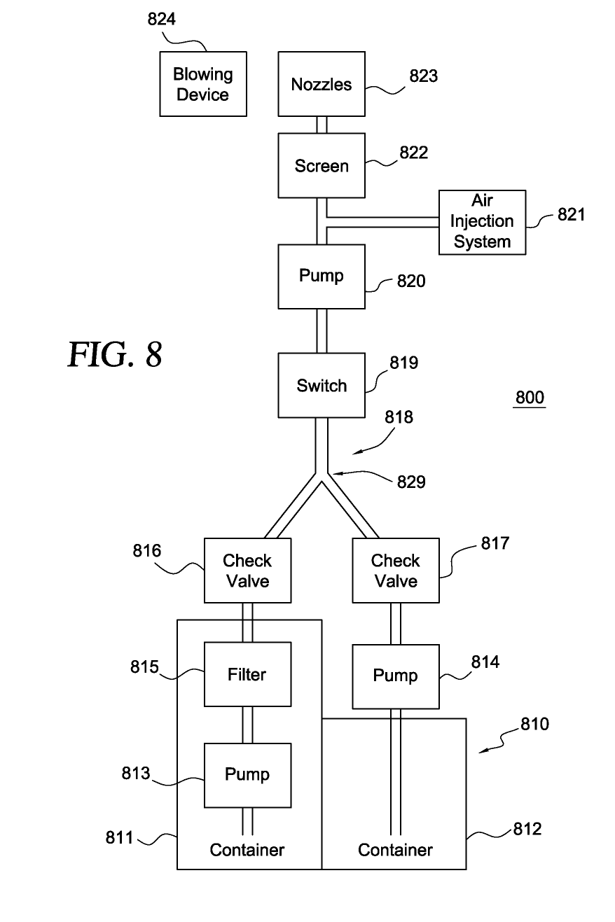

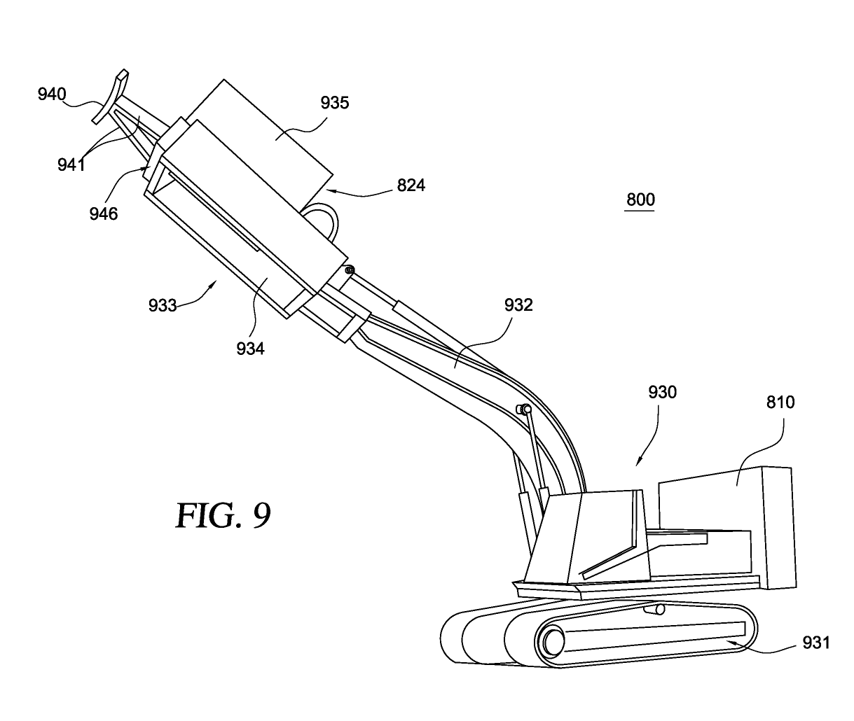

FIG. 8 illustrates a block diagram of a fire fighting apparatus or device 800, according to a second embodiment. FIG. 9 illustrates an isometric view of fire fighting device 800, according to the second embodiment. Fire fighting device 800 is merely exemplary and is not limited to the embodiments presented herein. Fire fighting device 800 can be employed in many different embodiments or examples not specifically depicted or described herein.

Referring to FIGS. 8-9, an apparatus for combating fires or fire fighting device 800 can include: (a) a vehicle portion or vehicle 930; (b) blade 940; (c) a fan or blowing device 824; (d) at least one container 810 configured to hold one or more fire suppressing solutions; (e) piping 818; (f) one or more pumps 813 and 814 mechanically coupled to container 810 and configured to at least partially pump the fire suppressing solution from container 810 into piping 818 at a first pressure; (g) a filter 815 coupled between an input of container 810 and piping 818; (h) one or more check valves 816 and 817 configured to keep fire suppressing solution from draining back into container 810 from piping 818; (i) a switch 819 configured to permit or prohibit the flow of fire suppressing solution from container 810 to nozzles 823; (j) at least one pump 820 coupled to piping 818 and configured such that pump 820 increases the pressure in at least a part of piping 818 from the first pressure to a second pressure where the second pressure is greater than the first pressure; (k) an air injection system 821 coupled to piping 818 and configured to inject air into the fire suppressing solution; (1) two or more nozzles 823; and (m) a screen 822 located between piping 818 and the two or more nozzles 823.

Vehicle 930 can include: (a) a base portion 931; (b) an arm 932; and (c) an adjustable height portion 933 coupled to base portion 931 using arm 932. Piping 818 can extend from base portion 931 to adjustable height portion 933 via arm 932. In various examples, vehicle 930 is configured such that a height of adjustable height portion 933 relative to base portion 931 can be adjusted. In some examples, arm 932 can be considered part of adjustable height portion 933. In some examples, vehicle 930 can be similar or identical to vehicle portion 400 (FIG. 1). In other examples, vehicle 930 can be a 345BL Series Excavator from Caterpillar, Inc. in Peoria, Ill.

Blade 940 can be located at a front 946 of adjustable height portion 933. In some examples, blade 940 can be used in stirring a burning pile or pushing trees over to clear an area. In some examples, blade 940 can be removably coupled to adjustable height portion 933 using one or more supports 941. Blade 940 can be a 10 feet wide blade.

In various examples, container 810 can include: (a) a container 811 configured to hold water; and (b) a container 812 configured to hold surfactant. In some examples, container 811 can be designed to hold approximately 2,500 gallons of water, and container 812 can be designed to hold approximately 90 gallons of surfactant. In other examples, container 810 can be similar or identical to tank 305.

The fire suppressing solution comprises the water and the surfactant. In some examples, the fire suppressing solution can be a 0.1% to 1.0% surfactant solution. In other examples, the first suppression solution can include any of the formulations previously discussed. In some examples, the water and the surfactant can be mixed to form the fire suppressing solution at joint 829.

Container 810 can be located at and coupled to the base portion 931. For example, container 810 can be welded to base portion 931 or attached to base portion 931 using a support bracket. In some examples, container 811 and/or container 812 can be lined (e.g., epoxy lined) to limit the amount of particulates (e.g., rust particles) that detach from container 811 and/or 812 and enter the fire suppressing solution.

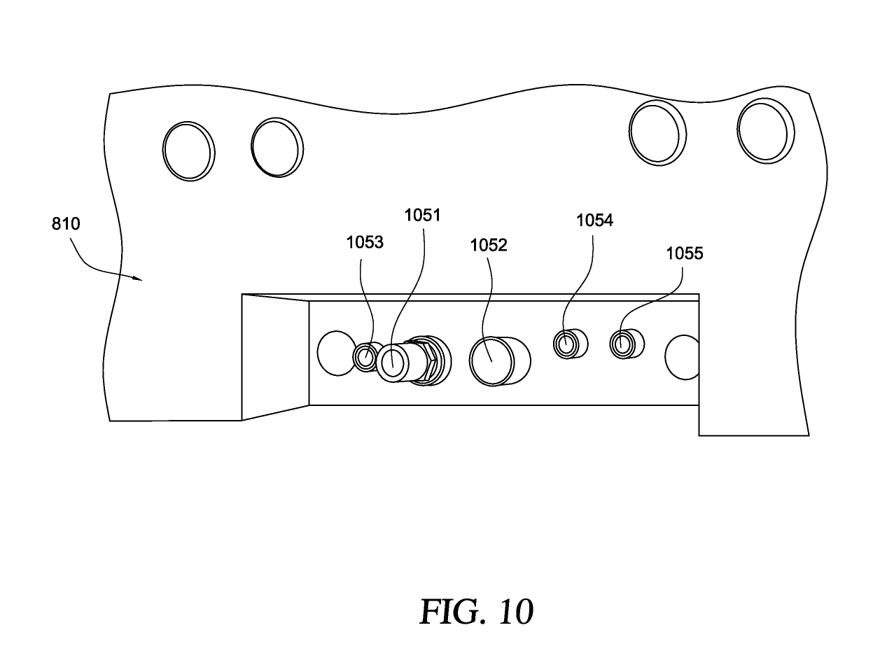

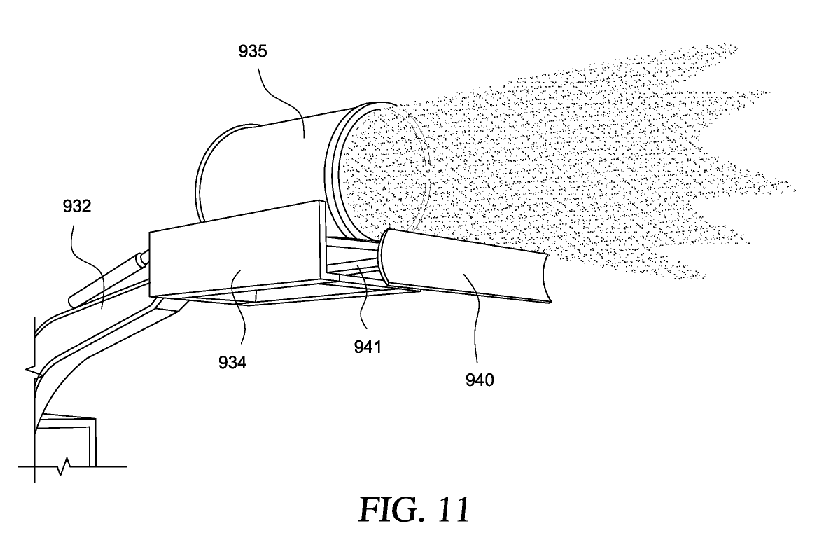

As illustrated in FIG. 10, container 811 can include: (a) fill port 1051; (b) a vent port 1052; and (c) a drain port 1053. In some examples, fill port 1051 can be used to fill container 811 with water, and vent port 1052 can be used to vent the container 811 during the filling and extracting process. In various embodiments, drain port 1053 can be configured to drain filter 815. In other embodiments, drain port 1053 can be used to drain container 811 if necessary. Ports 1051, 1052, and/or 1053 can be sealed to allow container 811 to be pressurized. In various embodiments, fill port 1051 and vent port 1052 are interchangeable. In some examples, fill port 1051 can be configured to couple to a standard fire hose. In the same or different examples, fill port 1051 can have a 2.5 inch or 3 inch diameter.

Similarly, container 812 can include: (a) fill port 1054; and (b) a vent port 1055. In some examples, fill port 1054 can be used to fill container 812 with surfactant, and vent port 1055 can be used to vent the container 812 during the filling and extracting process. In various embodiments, fill port 1054 and vent port 1055 are interchangeable. In other examples, container 812 can also include a drain port.

Returning to FIG. 8, pump 813 can be mechanically coupled to container 811 and configured to pump the water from container 811 into piping 818. In some examples, pump 813 can be a 4-inch pump powered by a 20 horsepower hydraulic motor coupled to an auxiliary pump of vehicle 930.

In some examples, pump 813 can be submersible and located near the lowest point in container 811. In some examples, pump 813 is located in container 811 to save space, help cool pump 813, and improve the efficiency (and lifetime) of pump 813 by having it push water from container 811 instead of pulling the water from container 811. In other examples, pump 813 can be located at other portions of container 811 or outside of container 811. Using pump 813, the water leaves container 811 at a first predetermined pressure (e.g., 80 psi).

Pump 814 can be mechanically coupled to container 812 and configured to pump the surfactant from container 812 into piping 818. In some examples, pump 814 can be a soap pump. In the example illustrated in FIG. 8, pump 814 is located outside of container 812. In other examples, pump 814 can be located inside container 812. Pump 814 can be a 24-volt electric pump configured to pump 2.4 gallons of liquid per minute. In some examples, pump 813 and/or 814 can be controlled by a user in a cab of vehicle 930. In some examples, pump 813 and/or 814 can be similar or identical to pump 302 (FIG. 6).

Filter 815 can be coupled to out water line of container 811. In some examples, filters 815 and 825 can be located in containers 811 and 812, respectively. In other examples, filters 815 and/or 825 are located outside of containers 811 and/or 812, respectively.

Filter 815 can filter out any large particulates in the water. In some examples, nozzles 823 can be easily clogged, so filter 815 can be used to remove the particulates from the water (and/or fire suppressing solution) before the fire suppressing solution enters nozzles 823. In some examples, to avoid the introduction of any particulates into the fire suppressing solution after filtering the water, all of the surfaces of fire fighting device 800 that contact the fire suppressing solution after the water passes through filter 815 can be made from stainless steel. In various embodiments, filter 815 can include five standard swimming pool cartridge filters. For example, the five standard swimming pool cartridge filters can be coupled in parallel to allow a predetermined volume of water to be filtered in a predetermined amount of time.

In other examples, fire fighting device 800 can include a second filter to filter the output of container 812. In still other examples, filter 815 can be coupled to piping 818 after the water and the surfactant are combined at joint 829.

In the example shown in FIG. 8, piping 818 is shown to carry the fire suppressing solution between containers 811 and 812 and nozzles 823. It will be recognized that piping 818 can include two or more separate, discontinuous parts. As used herein, a “piping” can include two or more parts or two or more different, separate pipes. In some examples, the piping can be discontinuous. For example, a first portion of the piping 818 can be coupled to an input of pump 820, and a second portion of piping 818 can be coupled to the output of pump 820. In some examples, different portions of the piping can be made from different materials. In some examples, the piping can include one or more joints (e.g., joint 829).

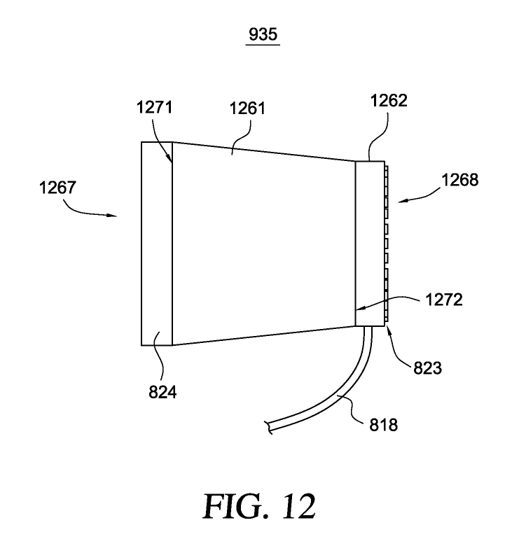

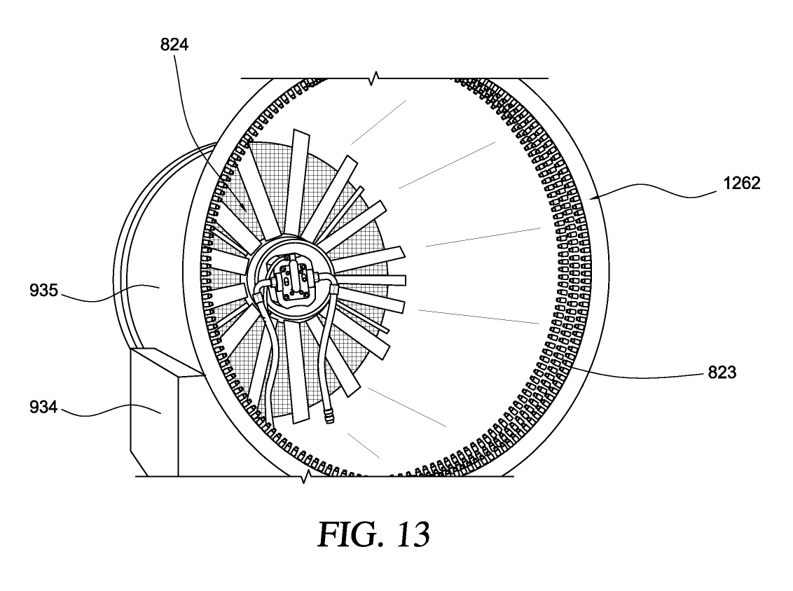

FIG. 11 illustrates an isometric side and front view of blower portion 935, holder portion 934, blade 940, and a portion of arm 932, according to the second embodiment. FIG. 12 illustrates a side diagram of blower portion 935, according to the second embodiment. FIG. 13 illustrates an isometric front view of blower portion 935 and holder portion 934, according to the second embodiment.

In some examples, holder portion 934 can be used to couple blower portion 935 and blade 940 to adjustable height portion 933. In some examples, air injection system 821 (FIG. 8) and pump 820 (FIG. 8) can be enclosed in holder portion 934.

Returning to FIG. 8, pump 820 can be used to pump the fire suppressing solution from base portion 931 (FIG. 9) to adjustable height portion 933 (FIG. 8). Furthermore, pump 820 can be used to increase the pressure of the fire suppressing solution in piping 818 from the first predetermined pressure to a second predetermined pressure. For example, the pumping of the fire suppressing solution through pump 820 can increase the pressure in at least a portion of piping 818 from 80 psi to 150 psi. In some examples, pump 820 can be a four-inch centrifugal pump powered by a variable speed 30-horsepower hydraulic motor. In various embodiments, pump 820 can be similar or identical to pump 270 (FIG. 7).

Air injection system 821 can be used to in-line aerate the fire suppressing solution. In some examples, air injection system 821 can include a bell around a pressurized pipe. The pressurized pipe can include hundreds of small holes so that, when compressed air is introduced into the bell, the air is injected into the fire suppressing solution.

Referring to FIGS. 8 and 11-13, fan portion or blower portion 935 can include: (a) blowing device 824; (b) fan housing 1261; (c) nozzles 823; (d) screen 822; and (e) a misting ring 1262. In other examples, blower portion 935 can further include pump 820 and air injection system 821.

Blower portion 935 can have back end 1267 and front end 1268 opposite end 1267. In some examples, air can be drawn into blower portion 935 at back end 1267 by blowing device 824. The air can pass through fan housing 1261 into misting ring 1262. Nozzles 823 are position at front end 1268 and can emit the fire suppressing solution into the stream of air produced by blowing device 824.

In some examples, blowing device 824 can be similar or identical to fan 205 (FIG. 2). In the same or different embodiments, blowing device 824 can be an 84-inch axial fan with a variable speed 90 horsepower hydraulic motor and an overhung load adapter. Blowing device 824 can be equipped with a check valve that allows the fan to spin in only one direction. Blowing device 824 can spin at over 1,000 revolutions per minute and produce an approximately 70-mile per hour wind while displacing approximately 200,000 cubic feet of air per minute.

Fan housing 1261 can be similar or identical to fan housing 210 of FIG. 2. In the same or different examples, fan housing 1261 can have back end 1271 and front end 1272. Back end 1271 can be coupled to blowing device 824. Front end 1272 can be coupled to misting ring 1262. Air can enter fan housing 1261 at back end 1271 and exit fan housing 1261 at front end 1272. In many examples, the internal diameter of fan housing 1261 can decrease between back end 1271 and front end 1272.

In some examples, misting ring 1262 can include nozzles 823. Nozzles 823 can be located at front end 1268 of blower portion 935 and mechanically coupled to piping 818 such that nozzles 823 can emit the fire suppressing solution, as shown in FIG. 11. FIG. 13 illustrates an example of a configuration of nozzles 823.

In some examples, misting ring 1262 and nozzles 823 can be similar or identical to misting ring 248 and nozzles 242 of FIG. 2. In other examples, misting ring 1262 can include three rows of 168 nozzles for a total of 504 nozzles. In some examples, the nozzles can be at an angle approximately perpendicular to the direction of air flow out of blowing device 824. In various embodiments, nozzles 823 can be #2 Whirljet nozzles. In the same or different embodiments, nozzles 823 can each output between 0.1 and 0.4 gallons of fire suppressing solution per minute. Misting ring 1262 can be constructed of stainless steel to help prevent rust from plugging nozzles 823. In some examples, the nozzles can be located at a periphery of an outlet of blowing device 824.

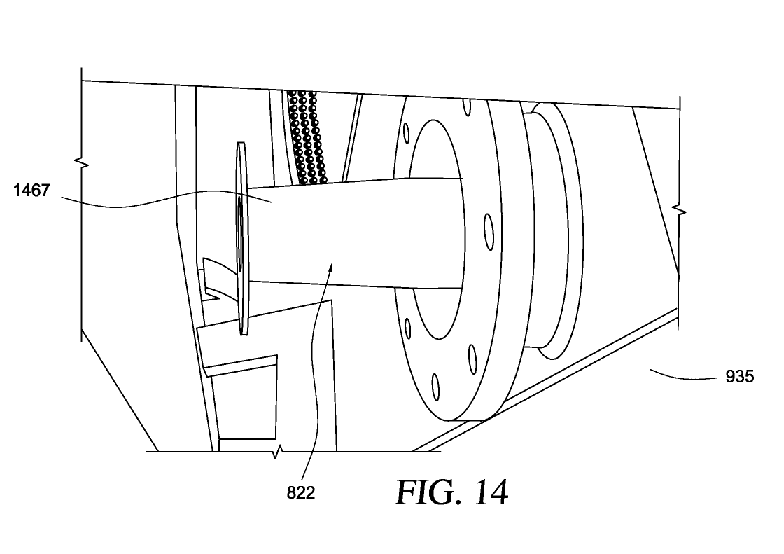

Before the fire suppressing solution enters nozzles 823, the fire suppressing solution can pass through a screen 822. Screen 822 can be coupled to piping 818 after air injection system 821 and just before the fire suppressing solution enters misting ring 1262 and nozzles 823. In some examples, screen 822 can cavitate the fire suppressing solution. For example, screen 822 can turn soapy water into suds. As illustrated in FIG. 14, screen 822 can include a cylindrical tube 1467 with micro holes through which the fire suppressing solution passes. In one example, the micro holes can be located along a length of a cylindrical tube 1467. In one example, the micro holes can have a 0.0036 inch diameter.

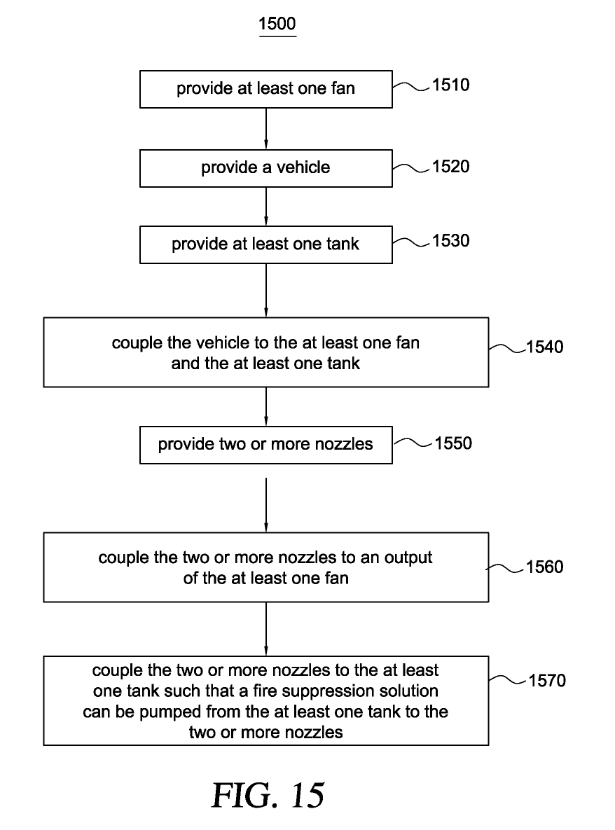

FIG. 15 illustrates a flow chart for an embodiment of a method 1500 of providing an apparatus for combating fires, according to an embodiment. Method 1500 is merely exemplary and is not limited to the embodiments presented herein. Method 1500 can be employed in many different embodiments or examples not specifically depicted or described herein. In some embodiments, the activities, the procedures, and/or the processes of method 1500 can be performed in the order presented. In other embodiments, the activities, the procedures, and/or the processes of the method 1500 can be performed in any other suitable order. In still other embodiments, one or more of the activities, the procedures, and/or the processes in method 1500 can be combined or skipped.

Method 1500 of FIG. 15 includes an activity 1510 of providing at least one fan. As an example, the fan can be similar or identical to fan 205 or blowing device 824 of FIGS. 2 and 8, respectively.

Method 1500 in FIG. 15 continues with an activity 1520 of providing a vehicle. As an example, the vehicle can be similar or identical to vehicle portion 400 or vehicle 930 of FIGS. 1 and 9, respectively.

Subsequently, method 1500 of FIG. 15 includes an activity 1530 of providing at least one tank. As an example, the tank can be similar or identical to tank portion 300 or container 810 of FIGS. 1 and 8, respectively.

Next, method 1500 of FIG. 15 includes an activity 1540 of coupling the vehicle to the at least one fan and the at least one tank. In some examples, the vehicle coupled to the tank and the fan can be similar or identical to the coupling of vehicle portion 400 to tank portion 300 and fan 205, as illustrated in FIG. 1. In other examples, the vehicle coupled to the tank and the fan can be similar or identical to the coupling of vehicle 930 to container 810 and blowing device 824, as illustrated in FIG. 9.

Method 1500 in FIG. 15 continues with an activity 1550 of providing two or more nozzles. As an example, the two or more nozzles can be similar or identical to nozzles 240 and/or 242 of FIG. 3 and/or nozzles 823 of FIG. 8.

Subsequently, method 1500 of FIG. 15 includes an activity 1560 of coupling the two or more nozzles to an output of the at least one fan. For example, the coupling of the two or more nozzles to an output of the at least one fan can be similar or identical to the coupling of nozzles 242 to an output of fan 205, as illustrated in FIG. 5. In another example, the coupling of the two or more nozzles to an output of the fan can be similar or identical to the coupling of nozzles 823 to an output of blowing device 824, as illustrated in FIG. 13.

Next, method 1500 of FIG. 15 includes an activity 1570 of coupling the two or more nozzles to the at least one tank such that a fire suppressing solution can be pumped from the at least one tank to the two or more nozzles. The coupling of the two or more nozzles to the at least one tank such that a fire suppressing solution can be pumped from the at least one tank to the two or more nozzles can be similar or identical to the coupling of nozzles 823 to container 810, as illustrated in FIG. 8.

In some examples, activity 1570 can include providing one or more pumps coupled to the at least one tank and the two or more nozzles such that the one or more pumps can pump the fire suppression solution from the at least one tank to the two or more nozzles. In some examples, the one or more pumps can be similar or identical to pumps 302 and 270 of FIGS. 6 and 7, respectively. In the same or different embodiments, the one or more pumps can be similar or identical to pumps 813, 814, and 820 of FIG. 8.

Although the invention has been described with reference to specific embodiments, it will be understood by those skilled in the art that various changes can be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that any details provided in relation to one embodiment can also apply to other embodiments when appropriate and the methods discussed herein may be implemented in a variety of embodiments, and that the foregoing discussion of certain of these embodiments does not necessarily represent a complete description of all possible embodiments. Accordingly, the detailed description of the drawings, and the drawings themselves, disclose at least one preferred embodiment, and may disclose alternative embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A fire fighting device comprising:
a blower portion with an air input region and an air output region;
at least one container configured to hold a fire suppressing solution;
first piping;
a first pump mechanically coupled to the at least one container and configured to at least partially pump the fire suppressing solution from the at least one container into the first piping at a first pressure;
a second pump coupled to the first piping, the second pump is configured such that the second pump increases a pressure in at least a part of the first piping from the first pressure to a second pressure, the second pressure is greater than the first pressure; and
two or more nozzles located at the blower portion and mechanically coupled to the first piping such that the two or more nozzles are configured to emit the fire suppressing solution.

2. The fire fighting device of claim 1, further comprising:
a filter coupled between a first one of the at least one container and at least a portion of the first piping.

3. The fire fighting device of claim 1, further comprising:
an air injection system coupled to the first piping and configured to inject air into the fire suppressing solution.

4. The fire fighting device of claim 1, further comprising:
a screen located between at least a portion of the first piping and the two or more nozzles and configured to cavitate the fire suppressing solution.

5. The fire fighting device of claim 1, further comprising:
a vehicle comprising:
a base portion; and
an adjustable height portion coupled to the base portion such that a height of the adjustable height portion relative to the base portion can be adjusted;
the at least one container is coupled to the base portion;
the blower portion and the two or more nozzles are located at the adjustable height portion; and
the first piping extends from the base portion to the adjustable height portion.

6. The fire fighting device of claim 5, further comprising:
a blade coupled to and located at a front of the adjustable height portion of the vehicle.

7. The fire fighting device of claim 1, wherein:
the at least one container comprises:
a first container configured to hold water; and
a second container configured to hold surfactant; and
the fire suppressing solution comprises the water and the surfactant.

8. The fire fighting device of claim 7, further comprising:
a third pump mechanically coupled to the second container of the at least one container, wherein:
the first pump is located within the first container of the at least one container and configured to pump the water from the first container of the at least one container into the first piping; and
the third pump is configured to pump the surfactant from the second container of the at least one container into the first piping.

9. The fire fighting device of claim 1, wherein:
the blower portion comprises:
a fan;
a fan housing with a first end and a second end, the first end of the fan housing coupled to the fan;
a nozzle ring coupled to the second end of the fan housing and the two or more nozzles; and
the two or more nozzles comprise three rings of nozzles.

10. An apparatus for combating fires, comprising:
a fan portion;
a vehicle portion; and
a tank portion,
wherein:
the fan portion comprises:
a fan;
at least one first nozzle section coupled to a periphery of an outlet of the fan; and
at least one second nozzle section coupled to the periphery of the outlet of the fan and adjacent to the first nozzle section.

11. The apparatus of claim 10, further comprising:
one or more pipes coupling the tank portion to the at least one first nozzle section and the at least one second nozzle section.

12. The apparatus of claim 10, further comprising:
a filter coupled to an output of the tank portion.

13. The apparatus of claim 10, further comprising:
an air injection system located between the tank portion and the at least one first and second nozzle sections.

14. The apparatus of claim 10, further comprising:
a screen located between the tank portion and the at least one first and second nozzle sections.

15. The apparatus of claim 10, wherein:
the vehicle portion comprises:
a base portion; and
an adjustable height portion coupled to the base portion such that a height of the adjustable height portion relative to the base portion can be changed;
the tank portion is coupled to the base portion; and
the fan portion is located at the adjustable height portion.

16. The apparatus of claim 10, further comprising:
a blade coupled to and located at a front of the adjustable height portion of the vehicle portion.

17. The apparatus of claim 10, wherein:
the tank portion comprises:
a first tank configured to hold water; and
a second tank configured to hold surfactant.

18. The apparatus of claim 17, wherein:
the tank portion further comprises:
a first pump mechanically coupled to the first tank and configured to pump the water from the first tank; and
a second pump mechanically coupled to the second tank and configured to pump the surfactant from the second tank.

19. A method of providing an apparatus for combating fires, comprising:
providing at least one fan;
providing a vehicle;
providing at least tank;
coupling the vehicle to the at least one fan and the at least one tank;
providing two or more nozzles;
coupling the two or more nozzle to an output of the at least one fan; and
coupling the two or more nozzles to the at least one tank such that a fire suppressing solution can be pumped from the at least one tank to the two or more nozzles.

20. The method of claim 19, wherein:
coupling the two or more nozzles to the at least one tank comprises:
providing one or more pumps coupled to the at least one tank and the two or more nozzles such that the one or more pumps can pump the first suppression solution from the at least one tank to the two or more nozzles.
